(19) United States
(12) Patent Application Publication
(10) Pub. No.: US 2004/0233931 A1
(43) Pub. Date: Nov. 25, 2004

(54) Method for calculation of jitter buffer and packetization delay

(76) Inventor: Ron Cohen, St Nes Ziona (IL)

Correspondence Address: Mark M Friedman, Bill Polkinghorn, Discovery Dispatch, 9003 Florin Way, Upper Marlboro, MD, 20772, US

(21) Appl. No.: 10/487,836

(22) PCT Filed: Sep. 12, 2002
(86) PCT No.: PCT/IL02/00760

Related U.S. Application Data
(60) Provisional application No. 60/318,314, filed on Sep. 12, 2001.

(51) Int. Cl. H04J 3/16; H04J 3/22

(52) U.S. Cl. 370/468

(57) ABSTRACT

A method for calculating jitter buffer depth in a packet switching network comprises receiving at a receiver N pairs of identical packets sized S₁ and S₂, sent by a sender with a known time interval between them, measuring an arrival time interval for each pair, calculating a speed factor using an average of the arrival time intervals and calculating the jitter buffer depth using the speed factor and the packet sizes. An optimized packetization delay at a sender can be then calculated using the jitter buffer depth.

### FIELD AND BACKGROUND OF THE INVENTION

The present invention relates to packet switched networks (PSN), and more particularly to circuit emulation of such networks. Circuit emulation requires keeping a jitter buffer in order to compensate the inherent jitter introduced by the packet switched network. A large jitter buffer can compensate for large jitter but introduces delay. A large delay should be avoided as the end-to-end delay of the entire circuit must be limited in order to provide adequate service. Therefore, it is important to find the right jitter buffer depth that answers best both needs, i.e. that introduces the minimal delay such that no packets are lost. One approach is to require the system (user) to configure the jitter buffer depth for each circuit, assuming he/she knows the right value. This approach is problematic, as the jitter introduced by the network may not be known in advance. Therefore, an automatic algorithm for selecting the right jitter buffer depth is required.

The current evolving standard for circuit emulation uses a configuration option to select the payload size of each packet. A packetizer accumulates a fixed set of bytes from a time division multiplexing (TDM) stream, places this set of bytes as payload on a packet and sends it from a sender to a far end (receiver) over the PSN. The packetizer therefore introduces a delay, called packetization delay. The packetization delay is the amount of data accumulated at the sender side before it starts sending the first packet carrying these data. Eqn. 1 describes the components that contribute to the end-to-end delay in a packet switched network.

Tᵣ=Tₛ+P+S*Σ1/Rᵢ+Fᵣ+J (1)

where S is the packet size in bits, Rᵢ is the rate of link i in bits/sec, Tₛ is the time at which the packet is sent, Tᵣ is the time at which the packet is received by the far end, P is the propagation delay along the path from sender to receiver, Fᵣ is the forwarding delay, and J is the jitter introduced by the packet network. A small packetization delay means small packet payloads and therefore poor network utilization, as the ratio of payload to transport overhead bytes becomes smaller. A compromise needs to be found between smaller end-to-end delay and better network utilization. Once more, an automatic algorithm for calculating the best packetization delay would provide a significant advantage over manual configuration

The delay experienced by the TDM service emulated over the wire is the sum of the jitter buffer kept on the receiver side, the sender's packetization delay, and the propagation and processing delay at each node. Each store-and-forward switch along the way adds jitter due to two major components: the packet forwarding delay that may vary depending on the implementation, and the load and queuing delay. The queuing delay is the amount of time a packet waits in queue before it starts being transmitted. We assume that the forwarding delay is negligible. The jitter buffer should make sure that information is not lost due to a queuing delay introduced within the network. Even if circuit emulation traffic is provided with preferred forwarding treatment, within each hop the arriving packet may still find a maximal sized packet already being transmitted, and would have to wait until in queue until this packet is sent. Therefore, to guard against this phenomenon the minimal jitter buffer depth should be:

JB=˜Sₘ*Σ1/Rᵢ=Sₘ*F (2)

where JB is the minimal jitter buffer depth, Sₘ is the largest size packet, and F=Σ1l/Rᵢ is a “speed factor”. For example, in an Ethernet based network, the value of Sₘ is around 1500 bytes, or 12 kbits. If the Ethernet network is composed of nine switches interconnected by ten 1 G-Ethemet links, we get JB=12 k*10/1 G/s=0.12 millisecond. This value of JB corresponds to keeping a buffer on the order of a TDM frame of 0.125 milliseconds. Assuming a network of two Fast Ethernet links (100 Mbit/s) and five 1 G-Ethernet links, we get JB to be equal or greater than 2 TDM frames (0.25 milliseconds).

TDM services enforce delay budgets on each segment in order to make sure that the services carried over the TDM infrastructure do not experience end-to-end delay that would cause service disruption. G-114 (ITU-T G-114 standard, February 1996) describes a recommendation for end-to-end delay planning across the national and international digital transmission lines. The end-to-end delay has contributions from the propagation delay as well as from the processing delay at each hop. Clause 3 describes the processing time allocation for equipment. The recommended processing time for a Digital Transit Exchange is 0.45 ms. For example, in the planning assumption for a pure digital network between local exchanges, the total processing delay is assumed to be 3 ms, including 5 digitally switched exchange switches and 1 PCM coder/decoder. For international calls, the national processing delay budget including multiplexers, switches and cross connects is 6 ms,.while for the high speed international links the processing delay budget is 3 ms.

An emulated circuit replaces a set of real TDM circuits. The delay introduced by the emulated circuit can be separated into propagation delay and processing delay. In order to compare the delay introduced to the standard, only the processing delay component is of interest. Eqn. 3 describes all the components that contribute to the end-to-end delay except the propagation delay. The equation assumes a constant packet size (no compression) S

Pᵣ=Pₖ+JB+S*Σ1/Rᵢ+F_{d}+E_{d} (3)

where E_{d} is the edge processing delay composed of the processing delay at the receiver E_{dr} and the processing delay at the sender E_{ds} (i.e. E_{d}=E_{dr}+E_{ds}), F_{d} is the forwarding delay, Pₖ is the packetization delay, and Pᵣ is the equivalent processing delay introduced by the emulated circuit. Pᵣ is compared to the standard TDM processing delay. Typical values for E_{dr} and E_{ds} are between 1 and 2 TDM frames, i.e. 250 milliseconds at each edge. F_{d} in modern packet switching systems is on the order of microseconds.

Single emulated pseudo wire can potentially replace the entire transmission infrastructure between local exchanges and even the entire national transmission infrastructure. However, a more conservative approach is that a single emulated pseudo wire replaces two digital transit exchanges. Therefore ideally Pᵣ<0.9 ms, but Pᵣ<3 ms is also acceptable.

The forwarding processing time F_{d} is negligible. The jitter buffer JB is known at the far end and can be signaled back to the near end. The edge processing delay at the near end is known and the processing delay at the far end can be either assumed to be the same as that at the near end or be signaled back to the near end.

There is thus a widely recognized need for, and it would be highly advantageous to have, a method that deals with the above issues of jitter buffer calculation and packetization delay, and which, specifically, provides an automatic algorithm for selecting the right jitter buffer and for calculating the optimal packetization delay.

### SUMMARY OF THE INVENTION

The present invention enables the automatic calculation of a jitter buffer depth, and based on this depth and the speed factor, the calculation of a maximal packetization delay.

According to the present invention there is provided a method for calculating jitter buffer depth in a packet switching network comprising the steps of: at a receiver, receiving from a sender a pair of packets with different sizes S₁ and S₂, the packets sent with a known sending time interval between them, the pair sending repeated N times, calculating a speed factor F using the repeated receipt of the N pairs of packets of different sizes, and calculating the jitter buffer depth using the speed factor.

According to one feature in the method of the present invention for calculating jitter buffer depth in a packet switching network, the calculation of the speed factor includes: at the receiver, measuring an arrival time interval for each N pair of packets, calculating an average of the N arrival time intervals and using that average and a difference of the packet sizes to extract the speed factor.

According to another feature in the method of the present invention for calculating jitter buffer depth in a packet switching network, the calculation of the jitter buffer is preceded by the step of providing a maximal package size, the calculation further including multiplying the maximal package size by the speed factor.

According to yet another feature in the method of the present invention for calculating jitter buffer depth in a packet switching network, the calculation of the jitter buffer depth further includes multiplying the maximal package size and the speed factor by a factor k, wherein k is an integer ranging between 2 and 4.

According to yet another feature in the method of the present invention for calculating jitter buffer depth in a packet switching network, the speed factor is calculated using equation 5.

According to yet another feature in the method of the present invention for calculating jitter buffer depth in a packet switching network, the calculation of the jitter buffer depth is done according to equation 6.

According to the present invention there is provided a method for optimizing the packetization delay at a sender in a packet switching network, comprising the steps of: receiving a jitter buffer depth, and calculating a maximal packetization delay using the jitter buffer depth.

According to one feature in the method of the present invention for optimizing the packetization delay at a sender in a packet switching network, the reception of a jitter buffer depth is preceded by a calculation of the jitter buffer depth that includes: at a receiver, receiving from a sender a pair of packets with different sizes S₁ and S₂, the packets sent with a known sending time interval between them, the pair sending repeated N times, calculating a speed factor F using the repeated receipt of the N pairs of packets of different sizes, and calculating the jitter buffer depth using the speed factor.

According to another feature in the method of the present invention for optimizing the packetization delay at a sender in a packet switching network, the calculation of a maximal packetization delay further includes: receiving as input a receiver processing delay E_{dr}, receiving as input a desired processing delay Pᵣ, and calculating the maximal packetization delay using equation 8.

According to yet another feature in the method of the present invention for optimizing the packetization delay at a sender in a packet switching network, the calculation of the speed factor includes: at the receiver, measuring an arrival time interval for each N pair of packets, calculating an average of the N arrival time intervals and using that average and a difference of the packet sizes to extract the speed factor.

According to yet another feature in the method of the present invention for optimizing the packetization delay at a sender in a packet switching network, the calculation of the jitter buffer is preceded by the step of providing a maximal package size, the calculation further including multiplying the maximal package size by the speed factor.

According to another feature in the method of the present invention for optimizing the packetization delay at a sender in a packet switching network, the calculation of the jitter buffer depth further includes multiplying the maximal package size and the speed factor by a factor k, wherein k is an integer ranging between 2 and 4.

According to another feature in the method of the present invention for optimizing the packetization delay at a sender in a packet switching network, the speed factor is calculated using equation 5.

### BRIEF DESCRIPTION OF THE DRAWINGS

The invention is herein described, by way of example only, with reference to the accompanying drawings, wherein:

FIG. 1 shows a preferred embodiment of the jitter buffer depth calculation steps;

FIG. 2 shows a preferred embodiment of the automatic packetization delay calculation steps;

### DESCRIPTION OF THE PREFERRED EMBODIMENTS

The present invention is of a method for calculation of jitter buffer and packetization delay. The description below deals first with the jitter buffer calculation, and then with the packetization delay that uses the calculated jitter buffer as input. The principles and operation of the disclosed herein many be better understood with reference to the drawings and the accompanying description.

Jitter Buffer Calculation

In order to calculate the jitter buffer depth, the receiver measures the arrival times Tᵣ₁ and Tᵣ₂ of two packets with different sizes S₁ and S₂ sent by the sender at times Tₛ₁ and Tₛ₂ respectively. For example, possible values of S₁ and S₂ could be 2320 and 320 bits respectively. While in this specific example the first package is larger than the second, in principle the method also works with the second being larger than the first, as long as an absolute value of the difference in packet sizes (S₁−S₂) is used in Eqns. 4 and 5 below. Typical values for the time difference between the two packets in each pair are 0.125 millisecond, equivalent to the duration of one TDM frame.

In the calculation below only time differences between packets of a pair are of importance, and therefore it is of no importance to coordinate time measurements between sender and receiver or when the time measurement has begun (time=0). According to Eqn. 1, the measured interval time at the receiver Iᵣ=Tᵣ₁−Tᵣ₂ has contributions from the jitter in the packet network as well as from a difference of propagation delay due to the different packet sizes

Iᵣ=T₁−Tᵣ₂=Tₛ₁−Tₛ₂+(S₁−S₂)Σ1/Rᵢ+J₁−J₂ (4)

Over several packets, the jitter difference Σ(J₁−J₂) will average to zero. We can extract the Σ1/Rᵢ factor which is the only unknown left.

F=Σ1/Ri=(Iᵣ−Iₛ)/(S₁−S₂) (5)

As mentioned in the Background, JB is the minimal size of the jitter buffer required, while Σ1/Rᵢ is the sum of interfaces on which queuing delay can be accumulated. This sum is equivalent to the speed factor calculated in Eqn. 2.

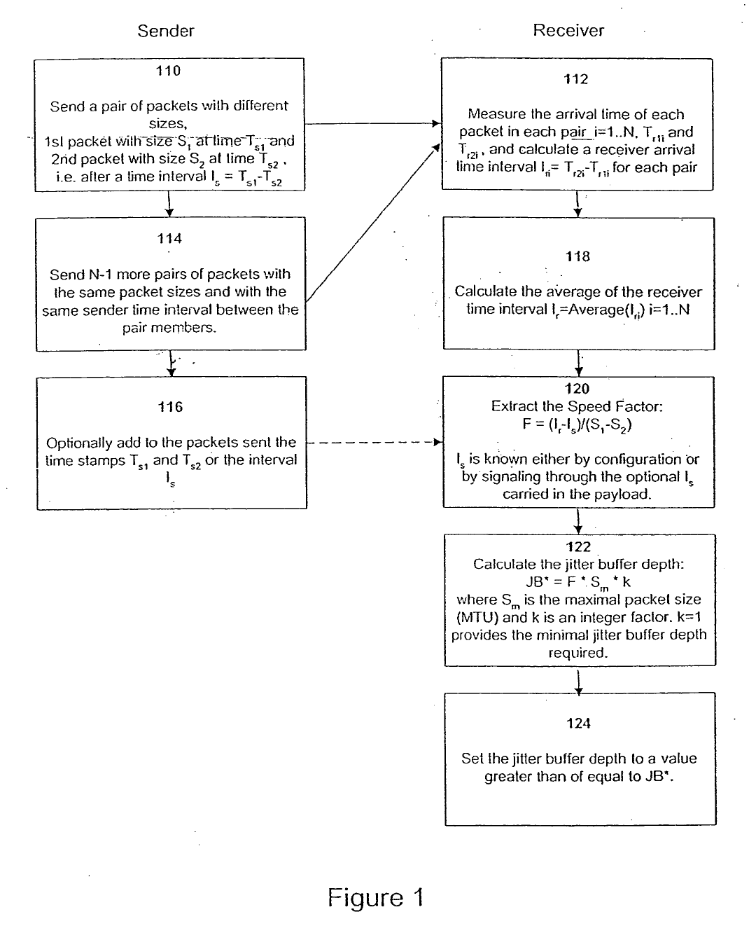

The jitter buffer is preferably calculated using a training session at startup. The training session sends repeatedly (N times) the same pairs of frames with different sizes (S₁ and S₂) that allow calculation of the speed factor and therefore the jitter buffer as described in Eqn. 2. N is preferably in the range 2-10, and most preferably 5-7. Assuming each packet is sent in a 0.125 ms interval, for N=6 this would mean a delay of only 15 ms to the setup time (which is of the order of seconds), a negligible addition Under run events, the jitter buffer can be re-evaluated periodically using the method described herein, and, if necessary, a new jitter buffer depth can be chosen. A preferred embodiment of the jitter buffer depth calculation steps is shown in the block diagram of FIG. 1.

In FIG. 1, a pair of packets having different sizes, a first packet with size S₁ and a second packet with size S₂, are sent respectively at sending times Tₛ₁ and Tₛ₂ by the sender in a sending step 110. The time interval between the two sending times Iₛ=Tₛ₂−Tₛ₁. The receiver measures the arrival times of each packet of the pair of packets, respectively Tᵣ₁ and Tᵣ₂, in a receiving step 112, and calculates a receiver arriving time interval for the pair Iᵣ=Tr₂−Tᵣ₁. In a repeating step 114, the sending of the same pairs as in step 110 is repeated N times using exactly the same packet sizes S₁ and S₂ and the same sending time interval Iₛ as in the first pair. These pairs are received by the receiver, where the calculation in step 112 of the arrival time interval for each pair in the receiver is similarly repeated. The sender may optionally provide the receiver with the time stamps Tₛ₁ and Tₛ₂ and/or the interval Iₛ in a notification step 116. In an averaging step 113, the receiver then calculates the average of all the received arrival time intervals Iᵣ(av), and, since Iₛ, S₁ and S₂ are known, extracts the speed factor F using Eqn. 5 (in which Iᵣ(av) replaces Iᵣ) in a speed factor extraction step 120. The receiver then calculates the jitter buffer depth in a jitter buffer calculation step 122 using Eqn. 2 multiplied by k (an integer factor), that is:

JB*=Sₘ*F*k (6)

Sₘ can be known either by configuration, or by using an MTU (Maximal Transmit Unit) discovery protocol as defined in RFC1191 (RFC1191, IETF, “Path MTU Discovery”, J. Mogul and S. Deering, November 1990). k=1 provides the minimal jitter buffer depth required. In a jitter buffer setting step 124, the receiver then sets JB to a value≧JB*.

Packetization Delay Calculation

Next we describe a preferred embodiment of the automatic calculation of the packetization delay. Assuming that the jitter buffer on the far end is signaled back to the near end, the packetization delay is calculated such that it answers the standard delay budgets. In principle, a jitter buffer depth obtained by any known method can be used to obtain the packetization delay as described below. However, the jitter buffer depth used in the automatic calculation of packetization delay according to the present invention is preferably obtained using the method described hereinabove.

The packetization delay should be chosen as a compromise between smaller end-to-end delay and better utilization of the packet network. The ideal packetization delay would be the maximal packetization delay that still solves Eqn. 3 where Pᵣ approximately equals 1 ms. The packet size S is composed of overhead and payload. Assuming no compression, the payload size is directly in proportion to the packetization delay

S=O+Y=O+C*Pₖ/0.125 ms (7)

where O is the number of overhead bits, Y is the number of payload bits, and C is the number of bits in a circuit frame. Therefore, assuming that the jitter buffer on the far edge is known, for example using the jitter buffer calculation described above by Eqns. 4-6, and that the forwarding delay is negligible, we can derive the ideal packetization delay to be given by Eqn. 8:

Pₖ=(Pᵣ−JB−F*O−E_{d})/(1+F*C/0.125) (8)

The value of JB needs to be sent from the far end to the near end or configured (by the system administrator). The O and C factors are known from the nature of the circuit and the encapsulation used. The Σ1/Rᵢ factor is the speed factor F that can either be signaled from the far side or configured. F is preferably calculated using Eqn. 5, however, it may also be obtained from configuration.

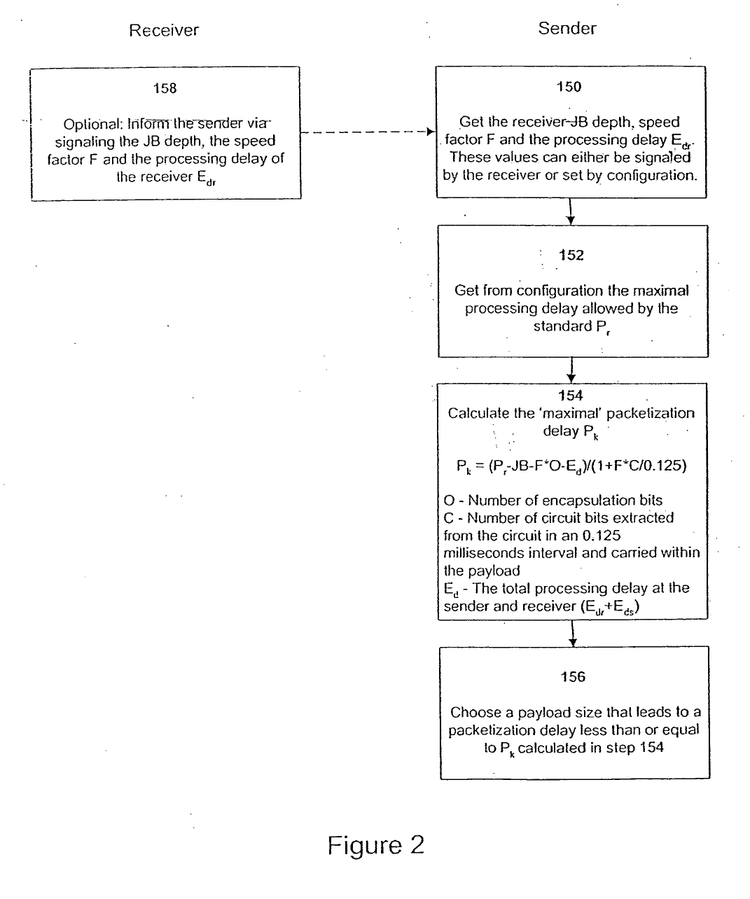

A preferred embodiment of the packetization delay calculation steps is shown in the block diagram of FIG. 2. The sender receives in a parameter signaling step 150 the jitter buffer depth JB, the speed factor F and the receiver processing delay E_{dr}, either directly as configured input or optionally from the receiver, as shown in a receiver sending block 158. The sender then gets from the configuration the desired processing delay Pᵣ as allowed by the standard in a processing delay obtaining step 152, and calculates the maximal packetization delay in a calculation step 154 using Eqn. 8. Finally, in a delay-choosing step 156, the sender chooses a payload size that leads to a packetization delay smaller than or equal to the maximal delay obtained in step 154.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

What is claimed is:

1. A method for calculating jitter buffer depth in a packet-switching network comprising the steps of:
a. at a receiver, receiving from a sender a pair of packets with different sizes S₁ and S₂, said packets sent with a known sending time interval between them, said sending of said pair of packets repeated N times;
b. calculating a speed factor F using said repeated receipt of said N pairs of packets; and
c. calculating the jitter buffer depth using said speed factor.

2. The method of claim 1, wherein said calculation of said speed factor includes:
i. at said receiver, measuring an arrival time interval for each of said N pair of packets, and
ii. calculating an average of said N arrival time intervals and using a difference of said packet sizes to extract said speed factor.

3. The method of claim 1, wherein said calculation of said jitter buffer is preceded by the step of providing a maximal package size, said calculation further including multiplying said maximal package size by said speed factor.

4. The method of claim 2, wherein said calculation of said jitter buffer depth further includes multiplying said maximal package size and said speed factor by a factor k, wherein k is an integer ranging between 2 and 4.

5. The method of claim 1, wherein said speed factor is calculated using equation 5.

6. The method of claim 4, wherein said calculation of said jitter buffer depth is done according to equation 6.

7. A method for optimizing the packetization delay at a sender in a packet switching network, comprising the steps of:
a. receiving a jitter buffer depth; and
b. calculating a maximal packetization delay using said jitter buffer depth.

8. The method of claim 7, wherein said reception of a jitter buffer depth is preceded by a calculation of said jitter buffer depth that includes:
i. at a receiver, receiving from a sender a pair of packets with different sizes S₁ and S₂, said packets sent with a known sending time interval between them, said sending of said pair of packets repeated N times;
ii. calculating a speed factor F using said repeated receipt of said N pairs of packets; and
iii. calculating said jitter buffer depth using said speed factor.

9. The method of claim 7, wherein said calculation of a maximal packetization delay further includes:
i. receiving as input a receiver processing delay E_{dr},
ii. receiving as input a desired processing delay Pᵣ, and
iii. calculating said maximal packetization delay using equation 8.

10. The method of claim 8, wherein said calculation of said speed factor includes:
i. at said receiver, measuring an arrival time interval for each of said N pair of packets, and
ii. calculating an average of said N arrival time intervals and using a difference of said packet sizes to extract said speed factor.

11. The method of claim 8, wherein said calculation of said jitter buffer is preceded by the step of providing a maximal package size, said calculation further including multiplying said maximal package size by said speed factor.

12. The method of claim 11, wherein said calculation of said jitter buffer depth further includes multiplying said maximal package size and said speed factor by a factor k, wherein k is an integer ranging between 2 and 4.

13. The method of claim 8, wherein said speed factor is calculated using equation 5.

14. The method of claim 13, wherein said calculation of said jitter buffer depth is done according to equation 6.
